(19) United States
(12) Patent Application Publication
(10) Pub. No.: US 2004/0018323 A1
(43) Pub. Date: Jan. 29, 2004

(54) Touch pad structure

(75) Inventors: Johnson Tsao, Taipei Hsieng (TW); Hsin-Yuan Yang, Taipei Hsieng (TW)

Correspondence Address: BACON & THOMAS, PLLC, 625 SLATERS LANE, FOURTH FLOOR, ALEXANDRIA, VA, 22314

(73) Assignee: INVENTEC APPLIANCES CORP.

(21) Appl. No.: 10/201,950

(22) Filed: Jul. 25, 2002

(51) Int. Cl. B32B 1/02

(52) U.S. Cl. 428/34.1; 428/34.4

(57) ABSTRACT

The invention is to provide a touch pad structure, which consists of a case having a containment space in which a touch pad is ensconced and visible through an opening formed in the surface of the said case. The said touch pad is constructed of a film and a glass base, wherein the peripheral edges thereof are aligned and fastened together by means of a conjoinment section with a separation layer between them. An adhesive layer situated a suitable distance away from the lateral edges of the said opening is disposed between the said case and film to bind them together. As such, when positions adjacent to the lateral edges of the said opening are pressed, they are correspondingly brought into continuity with the glass base, thereby preventing contact failure between the said film and glass base that results in selection incapability along the lateral edges of the said opening.

### BACKGROUND OF THE INVENTION

1) Field of the Invention

The invention herein relates to a touch pad structure.

2) Description of the Prior Art

Following developments in the integration of the conventional keyboard, mouse, trackball, track point, and touch pad, products on the market have facilitated data inputting by combining several input devices into a single device. Past iterations of the keyboard, mouse, trackball, and track point provided for high inputting efficiency and convenience, but with the advent of lightweight, thin, short, compact, powerful performance designed electronic products, conventional inputting devices are no longer capable of satisfying user requirements and, furthermore, such products lack the spatial characteristics to accommodate numerous inputting devices.

However, since certain touch pads that meet the requirements of multi-level unitary design have both keyboard and mouse functions as well as handwriting input and other user-friendly operating capabilities, and most notably its integration into an input-output device, the said touch pad is viewed as a state-of-the-art inputting device. Developed into a most mature and stable input-output interface, it is clearly a superior choice and when industrial designers conduct display-related research and development, the touch pad is generally selected as the input device for currently popular personal digital assistants (PDA), various household appliances (IA), notebook computers, mobile telephones, handheld PCs, and global positioning systems (GPS).

A conventional touch pad structure, referring to FIG. 1, consists of a case 1, the said case 1 having a containment space 10 as well as an opening 12 formed in the surface of the said case 1 that is contiguous with the said containment space 10; a touch pad 2 housed inside the said containment space 10, the said touch pad 2 constructed of a film 20 and a glass base 22, wherein the peripheral edges of the said film 20 and glass base 22 are aligned with a spacer post 24 creating a separation layer 26 between them and, furthermore, an insulated area 28 disposed at a position over and adjacent to the said spacer post 24 such that the film 20 is visible through the said opening 12 of the said case 1; and an adhesive layer 3 disposed between the said case 1 and film 20 and situated adjacent to the lateral edges of the said opening 12 that retains the said case 1 and film 20 together.

However, since the said adhesive layer 3 is situated along the lateral edges of the said opening 12, relatively large deformations cannot be produced at positions of the said film 20 adjacent to the said adhesive layer 3 (in some cases, no deformation is possible at all) such that the positions of said film 20 immediately proximal to the said adhesive layer 3 cannot be placed over and against the said glass base 22 and, as a result, the maximum deformation perimeter of the said film 20 is smaller than the lateral edges of the said opening 12; therefore, if a selection item is displayed at a position of the said glass base 22 adjacent to the lateral edges of the said opening 12, when this position on the said film 20 adjacent to the lateral edges of the said opening 12 is pressed, the said item cannot be selected because the said film 20 is incapable of deforming at the said position to establish continuity with the glass base 22.

Or, if another selection item is displayed on the said glass base 22 close to the lateral edges of the said opening 12, when the position (the said position is not aligned with the said selection item) on the said film 20 adjacent to the lateral edges of the said opening 12 is pressed, since the said film 20 is incapable of consistently producing deformations adjacent to the lateral edges of the said opening 12, but deformation may be produced at some positions on the said film 20 adjacent to the lateral edges of the said opening 12, the said film 20 and the said glass base 22 are brought together into continuity at the closest operable position along the lateral edges of the said opening 12, thought the said other selection item is not contacted, resulting in numerous user inconveniences and difficulties; furthermore, the placement of said adhesive layer 3 along the lateral edges of the said opening 12 is such that the viewing area boundary of the said glass base 22 is limited by the said adhesive layer 3.

### SUMMARY OF THE INVENTION

In view of the fact that the positions on the film of a conventional touch pad near the lateral edges of the said opening cannot be correspondingly brought into continuity with its glass base and results in an incapability to choose selection items at the said positions, the inventor of the invention herein conducted long-term, extensive research and experimentation that culminated in the successful development and design of a touch pad structure. The said structure consists of a case, the said case having a containment space in which a touch pad is ensconced, with the said touch pad visible through an opening formed in the surface of the said case. The said touch pad is constructed of a film and a glass base, wherein the peripheral edges of the said film and glass base are aligned and fastened together by means of a conjoinment section with a separation layer between them. An adhesive layer situated a suitable distance away from the lateral edges of the said opening is disposed between the said case and film to bind the said case and film together. As such, when positions adjacent to the lateral edges of the said opening are pressed, they are correspondingly brought into continuity with the glass base, thereby preventing contact failure between the said film and glass base that results in selection incapability along the lateral edges of the said opening.

The above and other objects, features and advantages of the present invention will become apparent from the following detailed description taken with the accompanying drawings.

### BRIEF DESCRIPTION OF THE DRAWINGS

FIG. 1 is a cross-sectional drawing of a conventional touch pad.

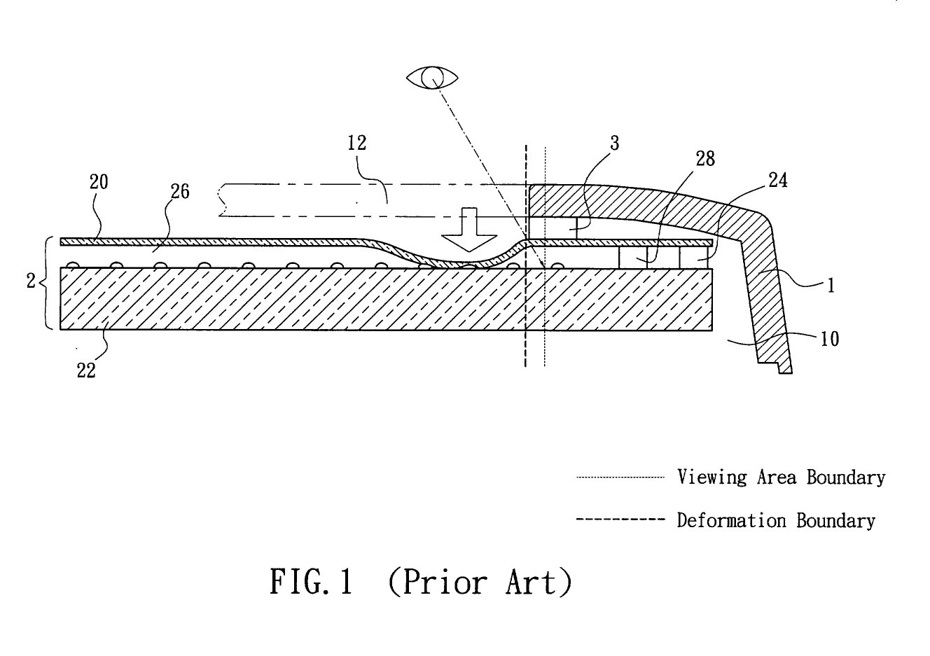

FIG. 2 is a cross-sectional drawing of the touch pad of the invention herein.

### DETAILED DESCRIPTION OF THE INVENTION

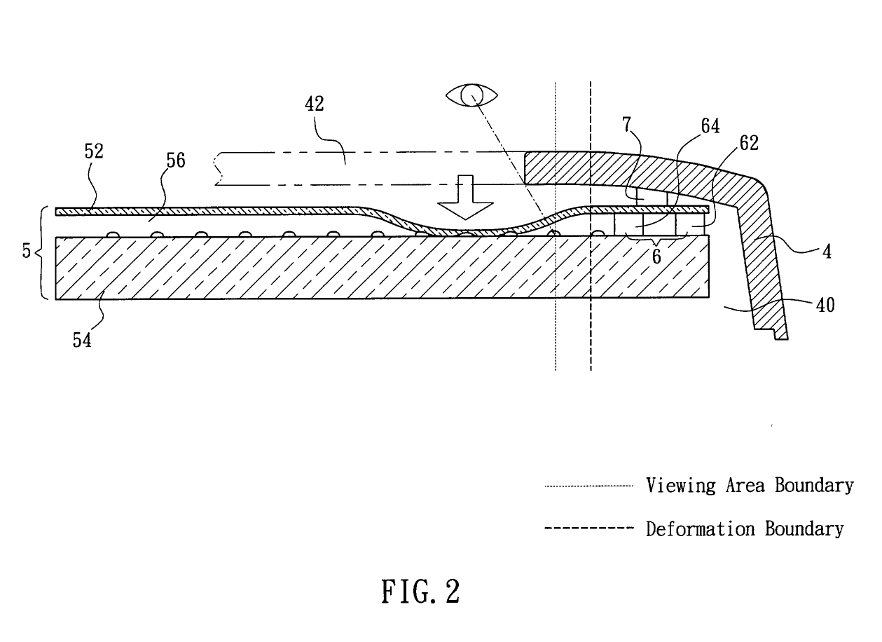

The invention herein is a touch pad structure, referring to FIG. 2, consisting of a case 4, the said case 4 having a containment space 40 as well as an opening 42 formed in the surface of the said case 4 that is contiguous with the said containment space 40; a touch pad 5 ensconced inside the said containment space 40, the said touch pad 5 constructed of a film 52 and a glass base 54, wherein the peripheral edges of the said film 52 and glass base 54 are aligned and fastened together by means of a conjoinment section 6 with a separation layer 56 between them such that the film 52 is visible through the said opening 42 of the said case 4; and an adhesive layer 7 situated a suitable distance away from the lateral edges of the said opening 42 and disposed between the said case 4 and film 52 that binds the said case 4 and film 52 together.

When the said film 52 adjacent to the lateral edges of the said opening 42 is pressed, the said film 52 becomes deformed and, furthermore, the change in curvature is relatively level and smooth such that the said film 52 contacts the said glass base 54 near the perimeter of the said opening 42, while also preventing contact failure between the said film 52 and glass base 54 at positions immediately proximal to the said opening 42 as well as erratic contact between the film 52 and the glass base 54 along the lateral edges of the said opening 42; additionally, the positions on the said glass base 54 adjacent to the said opening 42 are not limited by the said adhesive layer 7, which is confined to the case 4 such that the boundary delineating the viewing area of the said glass base 54 is larger than that of conventional touch pads.

In the embodiment of the invention herein, the said conjoinment section 6 consists of spacer posts 62 and insulated areas 64; the said spacer posts 62 are respectively situated between the peripheral edge of the said film 52 and the said glass base 54, thereby forming the said separation layer 56, and the said insulated areas 64 are respectively located at the lateral edges of the said opening 42 between a said spacer post 62 and the next nearest said spacer post 62 and, furthermore, the said insulated area 64 does not affect the boundary of the viewing area of the said glass base 54, with the said adhesive layer 7 disposed on the said film 52 facing a surface of the said case 4 between a said spacer post 62 and insulated area 64.

In the embodiment of the invention herein, the said glass base 54 is a transparent, conductive glass (ITO glass) and the said film 52 is a transparent, conductive film (ITO film); both the said ITO glass and ITO film each have an X-axis and Y-axis grid circuit, with a plurality of upper transparent electrodes disposed in the said ITO film and a plurality of lower transparent electrodes disposed in the said ITO glass.

When a finger, stylus, or other intermediary equivalent applies pressure against the upper electrodes, continuity is established between said upper and lower electrodes, thereby generating a difference in potential, the intersecting point of the said circuit acting as a switch utilized to produce a signal that is conveyed via wiring from the said touch pad to an electronic device that executes processing to calculate the coordinates of the pressed position, thereby determining the position and locus of the finger, stylus, or other intermediary equivalent based on the said coordinates.

While the invention has been described by means of specific embodiments, numerous modifications and variations could be made thereto by those skilled in the art without departing from the scope and spirit of the invention set forth in the claims.

1. A touch pad structure comprised of:
a case having a containment space as well as an opening formed in the surface of the said case that is contiguous with the said containment space;
a touch pad ensconced inside the said containment space, the said touch pad constructed of a film and a glass base, wherein the peripheral edges of the said film and the said glass base are aligned and fastened together by means of a conjoinment section with an appropriate separation layer between them, such that the said film is visible through the said opening of the said case; and
an adhesive layer situated a suitable distance away from the lateral edges of the said opening and disposed between the said case and the said film that binds the said case and the said film together.

2. A touch pad structure as claimed in claim 1 in which the said conjoinment section consists of spacer posts and insulated areas; the said spacer posts are respectively situated between the peripheral edge of the said film and the said glass base, thereby forming the said separation layer, and the said insulated areas are respectively located at the lateral edges of the said opening between a said spacer post and the next nearest said spacer post and, furthermore, the said insulated area does not affect the boundary of the viewing area of the said glass base, with the said adhesive layer disposed on the said film facing a surface of the said case between a said spacer post and a said insulated area.

3. A touch pad structure as claimed in claim 1 in which the said glass base is a transparent, conductive glass (ITO glass) and the said film is a transparent, conductive film (ITO film); both the said ITO glass and the said ITO film each have an X-axis and Y-axis grid circuit, with a plurality of upper transparent electrodes disposed in the said ITO film and a plurality of lower transparent electrodes disposed in the said ITO glass.
